(19) United States
(12) Patent Application Publication
(10) Pub. No.: US 2022/0270016 A1
(43) Pub. Date: Aug. 25, 2022

(54) METHOD FOR DETERMINING TEACHING STYLE, AND COMPUTER STORAGE MEDIUM

(71) Applicant: BEIJING XINTANG SICHUANG EDUCATION TECHNOLOGY CO., LTD, BEIJING (CN)

(72) Inventors: Song YANG, BEIJING (CN); Jian HUANG, BEIJING (CN); Fei YANG, BEIJING (CN); Zitao LIU, BEIJING (CN); Yan HUANG, BEIJING (CN)

(21) Appl. No.: 17/605,171

(22) PCT Filed: Apr. 23, 2020
(86) PCT No.: PCT/CN2020/086360

§ 371 Date: Apr. 28, 2022

(30) Foreign Application Priority Data
Apr. 23, 2019 (CN) 201910329291.1

(51) Int. Cl. G06Q 10/06; G06Q 50/20; G06F 17/18

(52) U.S. Cl. CPC G06Q 10/06393; G06Q 50/205; G06F 17/18

(57) ABSTRACT

Provided are a method for determining a teaching style, and a computer storage medium. The method comprises: performing a feature extraction operation on acquired teaching record data so as to obtain feature data corresponding to the teaching record data; by means of a teaching style prediction model, predicting, according to the feature data corresponding to the teaching record data, teaching style characterization data corresponding to the teaching record data; and performing, according to the teaching style characterization data corresponding to the teaching record data, a mapping operation in a pre-determined teaching style semantic space so as to determine a teaching style corresponding to the teaching record data. In the method, by means of a pre-determined teaching style semantic space, a teaching style corresponding to teaching record data can be accurately determined.

The present application claims the priority to a Chinese Patent Application with the application No. 201910329291.1, filed with the China National Intellectual Property Administration on Apr. 23, 2019, and entitled “Method for Determining Teacher Style, and Computer storage medium”, the entire contents of which are incorporated herein by reference.

### TECHNICAL FIELD

Embodiments of the present disclosure relate to the field of artificial intelligence, and more particularly, to a method for determining a teacher style and a computer storage medium.

### BACKGROUND

In a teaching scene, a teacher style is the judgment of the individual value of a teacher, and has an important influence on classroom quality. By accurately depicting the teaching style of the teacher, the teacher style can be accurately determined, which in turn can enable the artificial intelligence technology to have a very strong business landing scene in the teaching field. Therefore, it is a very important technical problem to accurately determine the teacher style.

Existing researches mainly identify emotional states of a teacher by the emotion recognition technology, and then determine the teacher style. Specifically, a discrete emotion model can be used to identify emotional states of the teacher, and then determine the teacher style. However, the emotional states (discrete emotional states, such as happy, angry, and so on) identified by using the discrete emotional model appear less in the teaching scene, have a weak connection with the teacher style, cannot reflect the actual teacher style of the teacher, and then cannot accurately determine the teacher style. In addition, a dimensional emotion model can also be used to identify the emotional states of the teacher, and then determine the teacher style. However, the dimensional emotion model is only used to describe the emotional states of the teacher, cannot accurately depict different teacher styles, and then cannot accurately determine the teacher style.

### SUMMARY

In view of this, one of the technical problems solved by the embodiments of the present disclosure is to provide a method for determining a teacher style and a computer storage medium to solve the problem that the teacher style cannot be accurately determined in the related art.

Embodiments of the present disclosure provide a method for determining a teacher style. The method includes: performing a feature extraction operation on teaching record data acquired, to obtain feature data corresponding to the teaching record data; predicting teacher style representation data corresponding to the teaching record data according to the feature data corresponding to the teaching record data through a teacher style prediction model; and performing a mapping operation in a predetermined teacher style semantic space according to the teacher style representation data corresponding to the teaching record data, to determine a teacher style corresponding to the teaching record data.

Embodiments of the present disclosure further provide a computer storage medium. The computer storage medium stores a readable program, the readable program including: an instruction configured for performing a feature extraction operation on teaching record data acquired, to obtain feature data corresponding to the teaching record data; an instruction configured for predicting teacher style representation data corresponding to the teaching record data according to the feature data corresponding to the teaching record data through a teacher style prediction model; and an instruction configured for performing a mapping operation in a predetermined teacher style semantic space according to the teacher style representation data corresponding to the teaching record data, to determine a teacher style corresponding to the teaching record data.

According to the solutions for determining the teacher style provided by the embodiments of the present disclosure, a feature extraction operation is performed on teaching record data acquired, to obtain feature data corresponding to the teaching record data; teacher style representation data corresponding to the teaching record data is predicted according to the feature data corresponding to the teaching record data through a teacher style prediction model; and a mapping operation is performed in a predetermined teacher style semantic space according to the teacher style representation data corresponding to the teaching record data, to determine a teacher style corresponding to the teaching record data. Compared with other existing methods, the teacher style corresponding to the teaching record data can be accurately determined through the predetermined teacher style semantic space.

### BRIEF DESCRIPTION OF THE DRAWINGS

To describe the solutions of the embodiments of the present disclosure or the prior art more clearly, the accompanying drawings to be used in the descriptions of the embodiments or the prior art will be described briefly below. Evidently, the accompanying drawings described below are merely drawings of some embodiments recited in the embodiments of the present disclosure. Those skilled in the art can obtain other drawings based on these accompanying drawings.

FIG. 1 shows a flowchart of operations of a method for determining a teacher style according to the first embodiment of the present disclosure;

FIG. 2A shows a flowchart of operations of a method for determining a teacher style according to the second embodiment of the present disclosure; and

FIG. 2B shows a schematic diagram of a teacher style semantic space according to the second embodiment of the present disclosure.

### DETAILED DESCRIPTION

In order to enable those skilled in the art to better understand the technical solutions in the embodiments of the present disclosure, the technical solutions in the embodiments of the present disclosure will be described clearly and completely below in combination with the accompanying drawings of the embodiments of the present disclosure. Obviously, the embodiments described are merely a part of the embodiments of the present disclosure, not all of the embodiments. All other embodiments obtained by those skilled in the art based on the embodiments of the present disclosure should fall within the scope of protection of the embodiments of the present disclosure.

The specific implementation of the embodiments of the present disclosure will be further described below in combination with the accompanying drawings of the embodiments of the present disclosure.

### First Embodiment

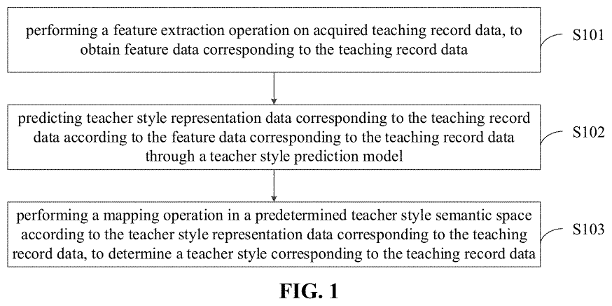

Referring to FIG. 1, a flowchart of operations of a method for determining a teacher style according to the first embodiment of the present disclosure is shown.

Specifically, the method for determining a teacher style provided by the embodiment of the present disclosure includes the following operations.

At block S101, a feature extraction operation is performed on teaching record data acquired, to obtain feature data corresponding to the teaching record data.

In this embodiment, the teaching record data acquired can include audio data or video data for recording teaching content, for example, audio data or video data with a duration of 10 seconds. In a case where the teaching record data acquired is specifically the audio data for recording the teaching content, the feature data corresponding to the teaching record data can be high-dimensional speech acoustic feature data extracted from the audio data. The speech acoustic feature data can include prosodic feature data, spectrum feature data, sound quality feature data, etc. of the audio. The speech acoustic feature data may be specifically a speech acoustic feature vector. In a specific embodiment, an existing speech acoustic feature extraction algorithm can be used to extract the high-dimensional speech acoustic feature data from the audio data. In a case where the teaching record data acquired is specifically the video data for recording the teaching content, the feature data of the teaching record data can be high-dimensional face feature data extracted from the video data. The face feature data can include feature data of the mouth area, feature data of the eye area, feature data of the cheek area, etc. The face feature data may be specifically a face feature vector. In a specific embodiment, the existing face feature extraction algorithm can be used to extract the high-dimensional face feature data from the video data.

At block S102, teacher style representation data corresponding to the teaching record data is predicted according to the feature data corresponding to the teaching record data through a teacher style prediction model.

In this embodiment, the teacher style prediction model can be any appropriate neural network model that can realize feature extraction or target object detection, including but not limited to a convolution neural network, an enhanced learning neural network, a generation network in an adversarial neural network, a depth neural network, etc. The specific structure in the neural network can be appropriately set by those skilled in the art according to actual needs, such as the number of layers of convolution layer, the size of convolution core, the number of channels, etc. The teacher style representation data can be understood as data used for representing the teacher style corresponding to the teaching record data, for example, a vector used for representing the teacher style corresponding to the teaching record data, the position data of the teacher style corresponding to the teaching record data in the teacher style semantic space, etc.

In this embodiment, in a case where the teacher style representation data corresponding to the teaching record data is predicted according to the feature data corresponding to the teaching record data through a teacher style prediction model, multiple preliminary teacher style prediction data corresponding to the teaching record data can be obtained based on the feature data through multiple low-level models of the teacher style prediction model; and final teacher style prediction data corresponding to the teaching record data can be obtained based on the multiple preliminary teacher style prediction data through the high-level model of the teacher style prediction model. Herein, the final teacher style prediction data is specifically the teacher style representation data. In this way, a teaching style preliminary prediction is performed on the teaching record data through the multiple low-level models included in the teacher style prediction model, and then, a teaching style final prediction is performed on the teaching record data, based on the teaching style preliminary prediction result through the high-level model included in the teacher style prediction model, thus the prediction accuracy of the teacher style prediction model for the teacher style corresponding to the teaching record data can be improved.

In this embodiment, in a case where multiple preliminary teacher style prediction data corresponding to the teaching record data are obtained based on the feature data through the multiple low-level models of the teacher style prediction model, feature extraction operations can be performed respectively on the feature data through a hidden layer, to obtain feature representation data respectively corresponding to the feature data; and mapping operations can be performed on the feature representation data respectively corresponding to the feature data through a prediction layer, to obtain multiple preliminary teacher style prediction data corresponding to the teaching record data. Herein, the feature representation data is specifically a feature representation vector. In this way, the feature extraction operations are respectively performed on the feature data through the hidden layer, and feature recoding is respectively performed on the feature data, thereby improving the robustness of the feature representation data respectively corresponding to the feature data, and improving the accuracy of the preliminary prediction of the teacher style corresponding to the teaching record data by the low-level model.

In this embodiment, in a case where the final teacher style prediction data corresponding to the teaching record data is obtained based on the multiple preliminary teacher style prediction data through the high-level model, the high-level feature representation data corresponding to the high-level model can be generated based on the multiple preliminary teacher style prediction data; and the final teacher style prediction data corresponding to the teaching record data can be obtained based on the high-level feature representation data through the high-level model. Herein, the high-level feature representation data is specifically a high-level feature representation vector. In this way, the high-level feature representation data corresponding to the high-level model is generated based on the preliminary teacher style prediction data, and then through the high-level model, the final teacher style prediction data corresponding to the teaching record data is obtained based on the high-level feature representation data, which can improve the accuracy of the final prediction of the teacher style corresponding to the teaching record data by the high-level model.

In this embodiment, in a case where the high-level feature representation data corresponding to the high-level model is generated based on multiple preliminary teacher style prediction data, the high-level feature representation data can be generated based on the multiple preliminary teacher style prediction data and the feature representation data respectively corresponding to the feature data. In this way, the high-level feature representation data is generated based on the preliminary teacher style prediction data and the feature representation data corresponding to the feature data, which can improve the robustness of the high-level feature representation data, and improve the accuracy of the final prediction of the teacher style corresponding to the teaching record data by the high-level model.

In this embodiment, in a case where the final teacher style prediction data corresponding to the teaching record data is obtained based on the high-level feature representation data through the high-level model, a feature extraction operation can be performed on the high-level feature representation data through the hidden layer in the high-level model, to obtain the feature representation data corresponding to the high-level feature representation data; and a mapping operation can be performed on the feature representation data corresponding to the high-level feature representation data through the prediction layer in the high-level model, to obtain the final teacher style prediction data corresponding to the teaching record data. In this way, the feature extraction operation is performed on the high-level feature representation data through the hidden layer, and feature recoding can be performed on the high-level feature representation data, thereby improving the robustness of the feature representation data corresponding to the high-level feature representation data, and improving the accuracy of the final prediction of the teacher style corresponding to the teaching record data by the high-level model.

At block S103, a mapping operation is performed in a predetermined teacher style semantic space according to the teacher style representation data corresponding to the teaching record data, to determine a teacher style corresponding to the teaching record data.

In this embodiment, the teacher style can be understood as an adjective describing the teaching style corresponding to the teaching record data.

In some optional embodiments, in a case where a mapping operation is performed in a predetermined teacher style semantic space according to the teacher style representation data corresponding to the teaching record data, Euclidean distances between the teacher style representation data and the respective teacher style representation data corresponding to multiple teacher styles in the teacher style semantic space can be determined; and the teacher style corresponding to the teaching record data can be determined based on the Euclidean distances.

In a specific example, in a case where the teacher style representation data corresponding to the input teaching record data m is predicted by using the trained teacher style prediction model based on the input teaching record data m, and the teacher style representation data is specifically the coordinate value (Pₘ, Aₘ) in the teacher style semantic space, the Euclidean distances between the coordinate value Pₘ, Aₘ) and the coordinate values corresponding to respective teacher styles in the teacher style semantic space can be calculated by:

dₘₛ=\sqrt{(Pₘ−Pₛ)²+(Aₘ−Aₛ)²} (s=1,2, . . . ,45)

where, dₘₛ represents the European distance between the coordinate value (Pₘ, Aₘ) and the coordinate value of a teacher style s in the teacher style semantic space. When the Euclidean distance between the coordinate value (Pₘ, Aₘ) and the coordinate value of a teacher style s′ in the teacher style semantic space is significantly less than the Euclidean distances corresponding to the other teacher styles in the teacher style semantic space, it is considered that the teacher style of the teaching record data m is s′. Specifically, if the differences between the Euclidean distance between the coordinate value (Pₘ, Aₘ) and the coordinate value of the teacher style s′ in the teacher style semantic space and the Euclidean distances corresponding to the other teacher styles in the teacher style semantic space are less than a preset value, it is considered that the teacher style of this teaching record data m is s′. If the Euclidean distances corresponding to several teacher styles are all relatively small, a distance threshold ε can be set, and the teacher styles corresponding to the Euclidean distances less than the distance threshold ε can be selected, and the teacher style corresponding to the teaching record data m can be considered as the mixture of the selected teacher styles.

Through the method for determining a teacher style provided by the embodiment of the present disclosure, a feature extraction operation is performed on teaching record data acquired, to obtain feature data corresponding to the teaching record data, and teacher style representation data corresponding to the teaching record data is predicted according to the feature data corresponding to the teaching record data through a teacher style prediction model; and a mapping operation is performed in a predetermined teacher style semantic space according to the teacher style representation data corresponding to the teaching record data, to determine a teacher style corresponding to the teaching record data. Compared with other existing methods, the teacher style corresponding to the teaching record data can be accurately determined through the predetermined teacher style semantic space.

### Second Embodiment

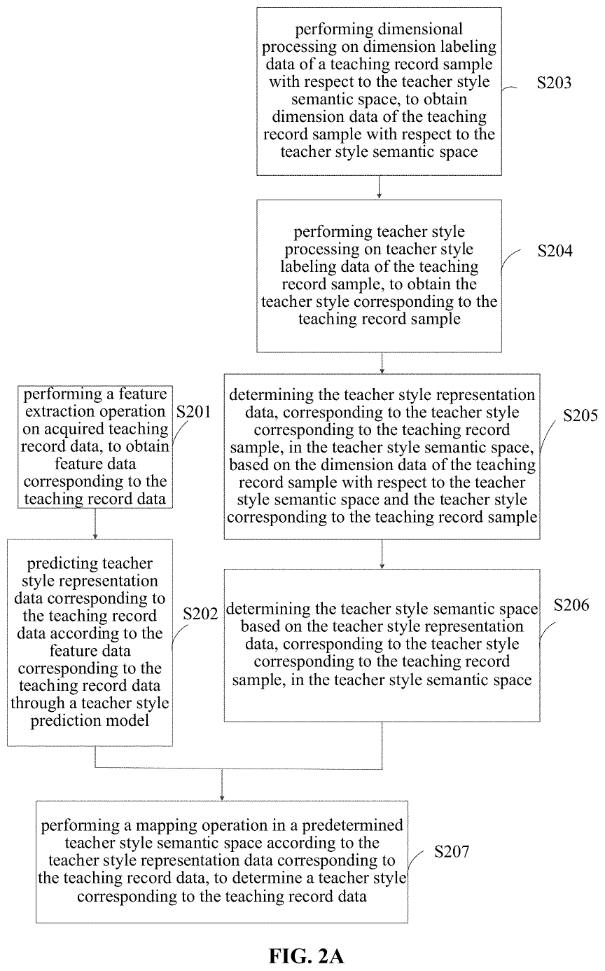

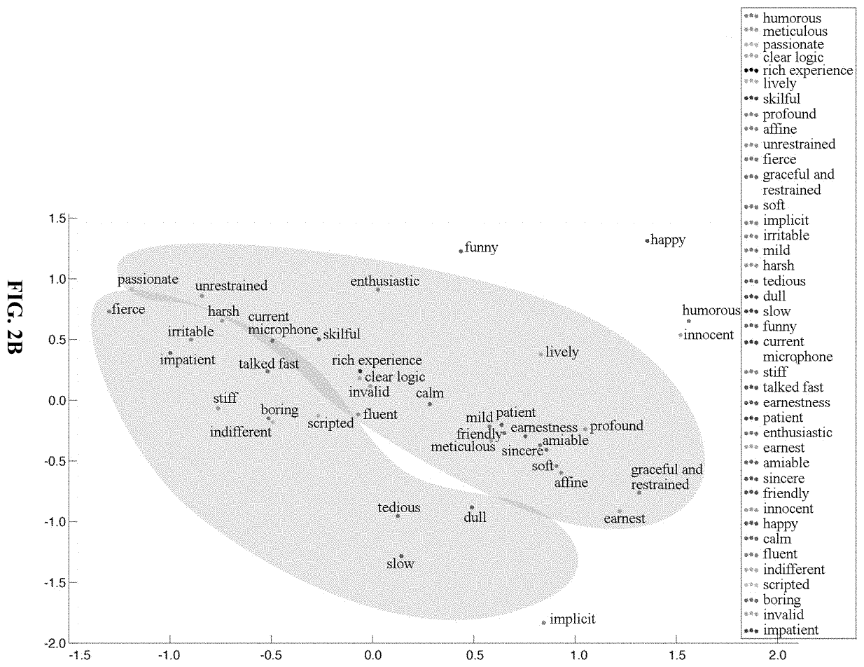

Referring to FIG. 2A, a flowchart of operations of a method for determining a teacher style according to the second embodiment of the present disclosure is shown.

Specifically, the method for determining a teacher style provided by the embodiment of the present disclosure includes the following operations.

At block S201, a feature extraction operation is performed on teaching record data acquired, to obtain feature data corresponding to the teaching record data.

This operation S201 is similar to the above operation S101 and will not be repeated here.

At block S202, teacher style representation data corresponding to the teaching record data is predicted according to the feature data corresponding to the teaching record data through a teacher style prediction model.

This operation S202 is similar to the above operation S102 and will not be repeated here.

At block S203, dimensional processing is performed on dimension labeling data of a teaching record sample with respect to the teacher style semantic space, to obtain dimension data of the teaching record sample with respect to the teacher style semantic space.

In this embodiment, the teaching record sample can include audio data or video data of the teaching content as a sample, for example, audio data or video data with a duration of 10 seconds. The teacher style semantic space can be understood as a space for establishing a mapping relationship between different teacher styles and specific values, and different teacher styles can be quantified by using the specific values. The teacher style semantic space may specifically be a two-dimensional space, a three-dimensional space, a multi-dimensional space, or the like. The dimension labeling data can be understood as data, with respect to a dimension of the teacher style semantic space, labeled by machine or manually on the teaching record sample. The dimension data can be understood as processed data of the teaching record sample with respect to at least one dimension of the teacher style semantic space.

In some optional embodiments, the dimension labeling data include first dimension labeling data and second dimension labeling data of the teaching record sample with respect to the teacher style semantic space. The first dimension labeling data can be understood as data, with respect to the first dimension of the teacher style semantic space, labeled by machine or manually on the teaching record sample. The second dimension labeling data can be understood as data, with respect to the second dimension of the teacher style semantic space, labeled by machine or manually on the teaching record sample. It can be seen that the teacher style semantic space is specifically a two-dimensional space including the first dimension and the second dimension. Specifically, the first dimension can be understood as the horizontal axis of the teacher style semantic space, which is used to indicate the horizontal coordinates of a teacher style mentioned below in the teacher style semantic space. The second dimension can be understood as the vertical axis of the teacher style semantic space, which is used to indicate the vertical coordinates of the teacher style mentioned below in the teacher style semantic space. When processing the dimension labeling data of the teaching record sample with respect to the teacher style semantic space, first dimension processing can be performed on the first dimension labeling data, to obtain first dimension data of the teaching record sample with respect to the teacher style semantic space; and second dimension processing can be performed on the second dimension labeling data, to obtain second dimension data of the teaching record sample with respect to the teacher style semantic space. Herein, the first dimension data can be understood as processed data of the teaching record sample with respect to the first dimension of the teacher style semantic space, and the second dimension data can be understood as processed data of the teaching record sample with respect to the second dimension of the teacher style semantic space.

In a specific example, the first dimension labeling data include response data of a first question and a second question set by multiple labeling models for the first dimension of the teacher style semantic space. Herein, the response data can be understood as the labeling value of the question set by the labeling model for the first dimension of the teacher style semantic space. Specifically, the first dimension of the teacher style semantic space can be set to correspond to two specific questions, for example, “sober vs. tired” (the first question), and “restrained (speaking with little fluctuation) vs. surprised (speaking with great fluctuation)” (the second question). The first dimension of the teacher style semantic space may be labeled by the labeling model (l=1, 2, 3, 4), to eliminate individual differences and obtain more robust labeling data. It is assumed that the total number of teaching record samples is N (n=1, 2, . . . , N). For the n-th teaching record sample, when the l-th labeling model labels the first dimension of the teacher style semantic space, the corresponding value is each question set thereof, and there are two questions (q=1, 2) in total. The labeling model will mark a value v_{lng} (indicating the value labeled by the labeling model l for the q-th question of the n-th teaching record sample) against each question. The value is between −3 and +3 in increments of 0.5, i.e., −3, −2.5, −2, . . . , +2.5, +3. Herein, the larger the value is, the greater the positive meaning is. For example, in the first question, the closer the value is to +3, the soberer the teacher corresponding to the teaching record sample is, and the closer the value is to −3, the more tired the teacher corresponding to the teaching record sample is. For example, for the first teaching record sample, when labeling the first dimension of the teacher style semantic space, the first labeling model marks a value v₁₁₁ against the first question and marks a value v₁₁₂ against the second question. Therefore, the first dimension labeling data include the values labeled by the labeling model l for the first question and the second question respectively.

In a specific example, when performing first dimension processing on the first dimension labeling data, the response data of the first question and the second question are normalized respectively to obtain normalized response data of the first question and the second question; first intermediate dimension labeling data, of the teaching record sample, labeled by multiple labeling models is determined based on the normalized response data of the first question and the second question; the first intermediate dimension labeling data are averaged, to obtain second intermediate dimension labeling data of the teaching record sample with respect to the teacher style semantic space; and the second intermediate dimension labeling data is normalized to obtain the first dimension data. Herein, the first intermediate dimension labeling data can be understood as the data, of the teaching record sample with respect to the first dimension of the teacher style semantic space, labeled by the labeling model. The reason why “the first intermediate dimension labeling data” is used is because it needs to be distinguished from “the first dimension labeling data” and “the second dimension labeling data” described above. The second intermediate dimension labeling data can be understood as the data of the teaching record sample with respect to the first dimension of the teacher style semantic space. The reason why “the second intermediate dimension labeling data” is used is because it needs to be distinguished from “the first dimension labeling data”, “the second dimension labeling data” and “the first intermediate dimension labeling data” described above.

In some optional embodiments, when normalizing the response data of the first question and the second question respectively, a first mean value and a first standard deviation of the response data of multiple teaching record samples with respect to the first question, and a second mean value and a second standard deviation of the response data of multiple teaching record samples with respect to the second question are determined; the response data of the first question is normalized based on the first mean value and the first standard deviation, to obtain normalized response data of the first question; and the response data of the second question is normalized based on the second mean value and the second standard deviation, to obtain normalized response data of the second question.

In a specific example, the labeling value of each labeling model (l=1, 2, 3, 4) for each question (q=1, 2) is normalized. First, the mean value and the standard deviation are calculated respectively on the two questions of all teaching record samples labeled by the four labeling models:

$${μ}_{lq} = {\sum }_{i = 1}^{N} \frac{{v}_{lqi}}{N} ( l = 1 , 2 , 3 , 4 ; q = 1 , 2 ) \\ {σ}_{lq} = \sqrt{{\sum }_{i = 1}^{N} \frac{{( {v}_{lqi} - {μ}_{lq} )}^{2}}{N}} ( l = 1 , 2 , 3 , 4 ; q = 1 , 2 )$$

where, v_{iqi} represents the labeling value of the l-th labeling model for the q-th question of the i-th teaching record sample, μ_{lq} represents the mean value of the labeling values of the l-th labeling model for the q-th question of all teaching record samples, and σ_{lq} represents the standard deviation of the labeling values of the l-th labeling model for the q-th question of all teaching record samples.

Then, the labeling values are normalized by a Z-score standardization method:

$$\overline{{v}_{lqi}} = \frac{{v}_{lqi} - {μ}_{lq}}{{σ}_{lq}} ( i = 1 , 2 , … , N ; l = 1 , 2 , 3 , 4 ; q = 1 , 2 )$$

where, v̅_̅{̅l̅q̅i̅}̅ represents the labeling value after the normalization of the q-th question of the i-th teaching record sample by the l-th labeling model.

In some optional embodiments, when determining first intermediate dimension labeling data, of the teaching record sample, labeled by multiple labeling models, based on the normalized response data of the first question and the second question, the difference of the normalized response data of the same labeling model for the first question and the second question is determined; and the difference is used as the first intermediate dimension labeling data, of the teaching record sample, labeled by the same labeling model.

In a specific example, the first intermediate dimension labeling data, of the teaching record sample, labeled by each labeling model (l=1, 2, 3, 4) labeling is calculated. The normalized labeling values of the labeling model l for the two questions of the n-th teaching record sample are and v̅_̅{̅b̅c̅1̅}̅ and v̅_̅{̅b̅c̅2̅}̅, respectively, and then the first intermediate dimension labeling data, of the n-th teaching record sample, labeled by the labeling model l is:

Pₗₙ=v̅ₗ̅ₙ̅₂̅−v̅ₗ̅ₙ̅₁̅ (l=1,2,3,4;n=1,2, . . . ,N)

where, Pₗₙ represents the first intermediate dimension labeling data, of the n-th teaching record sample, labeled by the labeling model l.

In a specific example, for the n-th teaching record sample, the solved first intermediate dimension labeling data, of the n-th teaching record sample, labeled by the four labeling models are averaged, to obtain the second intermediate dimension labeling data of the n-th teaching record sample with respect to the teacher style semantic space:

$${P}_{n} = \frac{{P}_{1 n} + {P}_{2 n} + {P}_{3 n} + {P}_{4 n}}{4} ( n = 1 , 2 , … , N )$$

where, Pₙ represents the second intermediate dimension labeling data of the n-th teaching record sample with respect to the teacher style semantic space.

In some optional embodiments, when normalizing the second intermediate dimension labeling data, the maximum value and the minimum value in the second intermediate dimension labeling data of multiple teaching record samples are determined; and the second intermediate dimension labeling data are normalized based on the maximum value and the minimum value, to obtain the first dimension data.

In a specific example, the solved second intermediate dimension labeling data are normalized to the range of 0 to 1 by using the min-max standardization method, to obtain the first dimension data of the final n-th teaching record sample with respect to the teacher style semantic space:

$$\overline{{P}_{n}} = \frac{{P}_{n} - min \{ {P}_{n} \}}{max \{ {P}_{n} \} - min \{ {P}_{n} \}} ( n = 1 , 2 , … , N )$$

where, P̅ₙ̅ represents the first dimension data of the n-th teaching record sample with respect to the teacher style semantic space. min{Pₙ} presents the minimum value in the second intermediate dimension labeling data of N teaching record samples, and max{Pₙ} represents the maximum value in the second intermediate dimension labeling data of the N teaching record samples.

In some optional embodiments, the second dimension labeling data include response data of a third question and a fourth question set by multiple labeling models for a second dimension of the teacher style semantic space. Herein, the response data can be understood as the labeling value of a question set by the labeling model for the second dimension of the teacher style semantic space. Specifically, setting the second dimension of the teacher style semantic space corresponds to two specific questions, for example, “friendly (friendly and interactive) vs. strictly” (the third question), “harsh voice vs. comfortable voice” (the fourth question). The labeling model (l=1, 2, 3, 4) can be arranged to label the second dimension of the teacher style semantic space, to eliminate individual differences and obtain more robust labeling data. It is assumed that the total number of teaching record samples is N (n=1, 2, . . . , N). For the n-th teaching record sample, when the l-th labeling model labels the second dimension of the teacher style semantic space, the corresponding value is marked against each question set thereof. There are in total two questions (q=3, 4). The labeling model will mark a value v_{lng} against each question, indicating that the value labeled by the labeling model l for the q-th question of the n-th teaching record sample. The value is between −3 and +3 in increments of 0.5, i.e., −3, −2.5, −2, . . . , +2.5, +3. Herein, the larger the value is, the greater the positive meaning is. For example, in the third question, the closer the value is to +3, the friendlier the teacher corresponding to the teaching record sample is; and the closer the value is to −3, the more strictly the teacher corresponding to the teaching record sample is. For example, for the first teaching record sample, when labeling the second dimension of the teacher style semantic space, the first labeling model marks a value v₁₁₃ against the third question and marks a value v₁₁₄ against the fourth question. Therefore, the second dimension labeling data include the values labeled by the labeling model/for the third question and the fourth question respectively.

In a specific example, when performing second dimension processing on the second dimension labeling data, the response data of the third question and the fourth question are normalized respectively to obtain normalized response data of the third question and the fourth question; third intermediate dimension labeling data, of the teaching record sample, labeled by multiple labeling models is determined based on the normalized response data of the third question and the fourth question; the third intermediate dimension labeling data are averaged, to obtain fourth intermediate dimension labeling data of the teaching record sample with respect to the teacher style semantic space; and the fourth intermediate dimension labeling data is normalized to obtain the second dimension data. Herein, the third intermediate dimension labeling data can be understood as the data, of the teacher style semantic space with respect to the second dimension, labeled by the labeling model on the teaching record sample. The reason why “the third intermediate dimension labeling data” is used is because it needs to be distinguished from “the first dimension labeling data, the second dimension labeling data, the first intermediate dimension labeling data, and the second intermediate dimension labeling data” described above. The fourth intermediate dimension labeling data can be understood as the data of the teaching record sample with respect to the second dimension of the teacher style semantic space. The reason why “the fourth intermediate dimension labeling data” is used is because it needs to be distinguished from “the first dimension labeling data, the second dimension labeling data, the first intermediate dimension labeling data, the second intermediate dimension labeling data, and the third intermediate dimension labeling data” described above.

In some optional embodiments, when normalizing the response data of the third question and the fourth question respectively, a third mean value and a third standard deviation of the response data of multiple teaching record samples with respect to the third question, and a fourth mean value and a fourth standard deviation of the response data of multiple teaching record samples with respect to the fourth question are determined; the response data of the third question is normalized based on the third mean value and the third standard deviation, to obtain normalized response data of the third question; and the response data of the fourth question is normalized based on the fourth mean value and the fourth standard deviation, to obtain normalized response data of the fourth question.

In a specific example, the labeling value of each labeling model (l=1, 2, 3, 4) for each question (q=3, 4) is normalized. First, the mean value and the standard deviation are calculated respectively on the two questions of all teaching record samples labeled by the four labeling models:

$${μ}_{lq} = {\sum }_{l = 1}^{N} \frac{{v}_{lqi}}{N} ( l = 1 , 2 , 3 , 4 ; q = 3 , 4 ) \\ {σ}_{lq} = \sqrt{{\sum }_{i = 1}^{N} \frac{{( {v}_{lqi} - {μ}_{lq} )}^{2}}{N}} ( l = 1 , 2 , 3 , 4 ; q = 3 , 4 )$$

where, μ_{lq} represents the mean value of the labeling values of the l-th labeling model for the q-th question of all teaching record samples, and σ_{lq} represents the standard deviation of the labeling values of the l-th labeling model for the q-th question of all teaching record samples.

Then, the labeling value is normalized by the Z-score standardization method:

$$\overline{{v}_{lqi}} = \frac{{v}_{lqi} - {μ}_{lq}}{{σ}_{lq}} ( i = 1 , 2 , … , N ; l = 1 , 2 , 3 , 4 ; q = 3 , 4 )$$

where, v̅_̅{̅l̅q̅i̅}̅ represents the labeling value after the normalization of the q-th question of the i-th teaching record sample by the l-th labeling model.

In some optional embodiments, when determining third intermediate dimension labeling data, of the teaching record sample, labeled by multiple labeling models, based on the normalized response data of the third question and the fourth question, the difference of the normalized response data of the same labeling model for the third question and the fourth question is determined; and the difference is used as the third intermediate dimension labeling data, of the teaching record sample, labeled by the same labeling model.

In a specific example, the third intermediate dimension labeling data, of the teaching record sample, labeled by each labeling model (l=1, 2, 3, 4) labeling is calculated. The normalized labeling values of the labeling model l for the two questions of the n-th teaching record sample are v̅ₗ̅ₙ̅₃̅ and v̅ₗ̅ₙ̅₄̅, respectively, and then the third intermediate dimension labeling data, of the n-th teaching record sample, labeled by the labeling model l is:

Aₗₙ=v̅ₗ̅ₙ̅₄̅−v̅ₗ̅ₙ̅₃̅(l=1,2,3,4;n=1,2, . . . ,N)

where, Aₗₙ represents the third intermediate dimension labeling data, of the n-th teaching record sample, labeled by the labeling model l.

In a specific example, for the n-th teaching record sample, the solved third intermediate dimension labeling data, of the n-th teaching record sample, labeled by the four labeling models are averaged, to obtain the fourth intermediate dimension labeling data of the n-th teaching record sample with respect to the teacher style semantic space:

$${A}_{n} = \frac{{A}_{1 n} + {A}_{2 n} + {A}_{3 n} + {A}_{4 n}}{4} ( n = 1 , 2 , … , N )$$

where, Aₙ represents the fourth intermediate dimension labeling data of the n-th teaching record sample with respect to the teacher style semantic space.

In some optional embodiments, when normalizing the fourth intermediate dimension labeling data, the maximum value and the minimum value in the fourth intermediate dimension labeling data of multiple teaching record samples are determined; the fourth intermediate dimension labeling data are normalized based on the maximum value and the minimum value, to obtain the second dimension data.

In a specific example, the solved fourth intermediate dimension labeling data are normalized to the range of 0 to 1 by using the min-max standardization method, to obtain the second dimension data of the final n-th teaching record sample with respect to the teacher style semantic space:

$$\overline{{A}_{n}} = \frac{{A}_{n} - min \{ {A}_{n} \}}{max \{ {A}_{n} \} - min \{ {A}_{n} \}} ( n = 1 , 2 , … , N )$$

where, A̅ₙ̅ represents the second dimension data of the n-th teaching record sample with respect to the teacher style semantic space. min{Aₙ} represents the minimum value in the fourth intermediate dimension labeling data of N teaching record samples, and max{Aₙ} represents the maximum value in the fourth intermediate dimension labeling data of N teaching record samples.

At block S204, teacher style processing is performed on teacher style labeling data of the teaching record sample, to obtain the teacher style corresponding to the teaching record sample.

In this embodiment, the teacher style labeling data can be understood as an adjective describing the teacher style labeled by machine or manually on the teaching record sample. The teacher style labeling data include teacher style labeling data, of the teaching record sample, labeled by multiple labeling models. The teacher style can be understood as the processed adjective describing the teaching style of the teaching record sample. Specifically, the teacher style is mainly defined by using different adjectives. First, 10000 questionnaires on the teacher style description are synthesized, to obtain 505 valuable adjectives, and then the uncommon adjectives are removed manually, to finally obtain 45 adjectives describing the teacher style (s=1, 2, . . . , 45), as shown in the table below.

| | | |
|---|---|---|
| impatient | tedious | unrestrained |
| strictly | resonant | easy |
| serious | lively | confused |
| affine | active | thorough |
| excited | fluent | free |
| indifferent | mild | happy |
| calm | gentle | lazy |
| disgust | soft | reluctant |
| dull | passionate | bored |
| amiable | irritable | vague |
| tired | hesitating | patient |
| disappoint | sincere | confident |
| quite | worried | worried |
| insipid | active | fierce |
| humorous | stress | stiff |

For the n-th teaching record sample, when the labeling model l labels the teacher style, the labeling model will select one of the determined 45 adjectives describing the teacher style to be labeled.

In some optional embodiments, when performing the teacher style processing on the teacher style labeling data of the teaching record sample, the amount of same teacher style labeling data in the teacher style labeling data, of the teaching record sample, labeled by multiple labeling models is determined; and the teacher style corresponding to the teaching record sample is determined based on the amount.

In a specific example, for the n-th teaching record sample, the adjectives describing the teacher style labeled by four labeling models (l=1, 2, 3, 4) are s₁ₙ, s₂ₙ, s₃ₙ and s₄ₙ respectively. For the n-th teaching record sample, if there are at least two or more same adjectives in s₁ₙ, s₂ₙ, s₃ₙ, and s₄ₙ, the teacher style of the n-th teaching record sample is the same adjective sₙ; otherwise, the teacher style is discarded.

At block S205, the teacher style representation data, corresponding to the teacher style corresponding to the teaching record sample, in the teacher style semantic space, is determined based on the dimension data of the teaching record sample with respect to the teacher style semantic space and the teacher style corresponding to the teaching record sample.

In this embodiment, the teacher style representation data can be understood as the coordinate data corresponding to the teacher style in the teacher style semantic space.

In some optional embodiments, when determining the teacher style representation data, corresponding to the teacher style, in the teacher style semantic space based on the dimension data and the teacher style data, the number of teaching record samples, with the same teacher style as the teacher style, in multiple teaching record samples is determined; and the teacher style representation data, corresponding to the teacher style, in the teacher style semantic space is determined based on the number and the dimension data. Specifically, when the teacher style representation data, corresponding to the teacher style, in the teacher style semantic space is determined based on the number and the dimension data, the teacher style representation data, corresponding to the teacher style, in the teacher style semantic space is determined based on the number, the first dimension data and the second dimension data.

In a specific example, for the n-th teaching record sample, after the first dimension data P̅ₙ̅ and the second dimension data A̅ₙ̅ with respect to the teacher style semantic space, and the teacher style sₙ are obtained, the teacher style sₙ is taken as a research object, and the coordinate data, corresponding to the teacher style sₙ, in the teacher style semantic space are determined. Specifically, for the teacher style sₙ of the n-th teaching record sample, it is set that the number of the teaching record samples contained for the teacher style sₙ is Nₛ, that is, the number of teaching record samples, with the same teacher style as the teacher style sₙ, in N teaching record samples is Nₛ, and then the coordinate data, corresponding to the teacher style sₙ, in the teacher style semantic space can be solved according to the following formula:

$${P}_{s} = {\sum }_{n = 1}^{{N}_{s}} \frac{\overline{{P}_{n}}}{{N}_{s}} ( s = 1 , 2 , … , 45 ) \\ {A}_{s} = {\sum }_{n = 1}^{{N}_{s}} \frac{\overline{{A}_{s}}}{{N}_{s}} ( s = 1 , 2 , … , 45 )$$

where, Pₛ represents the horizontal axis coordinate value of the teacher style sₙ in the teacher style semantic space, and Aₛ represents the vertical axis coordinate value of the teacher style sₙ in the teacher style semantic space.

At block S206, the teacher style semantic space is determined based on the teacher style representation data, corresponding to the teacher style corresponding to the teaching record sample, in the teacher style semantic space.

In this embodiment, for each different teacher style, the coordinate data (Pₛ, Aₛ) corresponding to the teacher style are solved, to constitute the teacher style semantic space, as shown in FIG. 2B. Specific coordinate data are used to quantify different teacher styles, and mapping relationships between the specific coordinate data and the different teacher styles are established. The teacher style semantic space is a two-dimensional model. The coordinate points in the space can correspond to the specific teacher styles, and different teacher styles can also correspond to the points determined in the space, such that the teacher style can be depicted more accurately.

At block S207, a mapping operation is performed in a predetermined teacher style semantic space according to the teacher style representation data corresponding to the teaching record data, to determine a teacher style corresponding to the teaching record data.

This operation S207 is similar to the above operation S103 and will not be repeated here.

On the basis of the first embodiment, dimensional processing is performed on dimension labeling data of a teaching record sample with respect to the teacher style semantic space, to obtain dimension data of the teaching record sample with respect to the teacher style semantic space; teacher style processing is performed on teacher style labeling data of the teaching record sample, to obtain a teacher style corresponding to the teaching record sample; teacher style representation data, corresponding to the teacher style, in the teacher style semantic space is determined based on the dimension data and the teacher style; and then the teacher style semantic space is determined based on the teacher style representation data, corresponding to the teacher style, in the teacher style semantic space. Compared with other existing methods, the teacher style can be accurately depicted based on the determined teacher style semantic space.

### Third Embodiment

Embodiments of the present disclosure further provide a computer storage medium. The computer storage medium stores a readable program, the readable program including: an instruction configured for performing a feature extraction operation on teaching record data acquired, to obtain feature data corresponding to the teaching record data; an instruction configured for predicting teacher style representation data corresponding to the teaching record data according to the feature data corresponding to the teaching record data through a teacher style prediction model; and an instruction configured for performing a mapping operation in a predetermined teacher style semantic space according to the teacher style representation data corresponding to the teaching record data, to determine a teacher style corresponding to the teaching record data.

Optionally, before the instruction configured for performing the mapping operation in the predetermined teacher style semantic space according to the teacher style representation data corresponding to the teaching record data, to determine the teacher style corresponding to the teaching record data, the readable program further includes: an instruction configured for performing dimensional processing on dimension labeling data of a teaching record sample with respect to the teacher style semantic space, to obtain dimension data of the teaching record sample with respect to the teacher style semantic space; an instruction configured for performing teacher style processing on teacher style labeling data of the teaching record sample, to obtain the teacher style corresponding to the teaching record sample; an instruction configured for determining the teacher style representation data, corresponding to the teacher style corresponding to the teaching record sample, in the teacher style semantic space, based on the dimension data of the teaching record sample with respect to the teacher style semantic space and the teacher style corresponding to the teaching record sample; and an instruction configured for determining the teacher style semantic space based on the teacher style representation data, corresponding to the teacher style corresponding to the teaching record sample, in the teacher style semantic space.

Optionally, the dimension labeling data includes first dimension labeling data and second dimension labeling data of the teaching record sample with respect to the teacher style semantic space; and the instruction configured for performing the dimensional processing on the dimension labeling data of the teaching record sample with respect to the teacher style semantic space, to obtain the dimension data of the teaching record sample with respect to the teacher style semantic space, includes: an instruction configured for performing first dimension processing on the first dimension labeling data, to obtain first dimension data of the teaching record sample with respect to the teacher style semantic space; and an instruction configured for performing second dimension processing on the second dimension labeling data, to obtain second dimension data of the teaching record sample with respect to the teacher style semantic space.

Optionally, the first dimension labeling data includes response data of a first question and a second question set by multiple labeling models for a first dimension of the teacher style semantic space; and the instruction configured for performing the first dimension processing on the first dimension labeling data, to obtain the first dimension data of the teaching record sample with respect to the teacher style semantic space, includes: an instruction configured for normalizing the response data of the first question and the second question respectively, to obtain normalized response data of the first question and the second question; an instruction configured for determining first intermediate dimension labeling data, of the teaching record sample, labeled by multiple labeling models, based on the normalized response data of the first question and the second question; an instruction configured for averaging the first intermediate dimension labeling data, to obtain second intermediate dimension labeling data of the teaching record sample with respect to the teacher style semantic space; and an instruction configured for normalizing the second intermediate dimension labeling data to obtain the first dimension data.

Optionally, the instruction configured for normalizing the response data of the first question and the second question respectively, to obtain the normalized response data of the first question and the second question, includes: an instruction configured for determining a first mean value and a first standard deviation of the response data of multiple teaching record samples with respect to the first question, and a second mean value and a second standard deviation of the response data of multiple teaching record samples with respect to the second question; an instruction configured for normalizing the response data of the first question based on the first mean value and the first standard deviation, to obtain the normalized response data of the first question; and an instruction configured for normalizing the response data of the second question based on the second mean value and the second standard deviation, to obtain the normalized response data of the second question.

Optionally, the second dimension labeling data includes response data of a third question and a fourth question set by multiple labeling models for a second dimension of the teacher style semantic space; and the instruction configured for performing the second dimension processing on the second dimension labeling data, to obtain the second dimension data of the teaching record sample with respect to the teacher style semantic space, includes: an instruction configured for normalizing the response data of the third question and the fourth question respectively, to obtain normalized response data of the third question and the fourth question; an instruction configured for determining third intermediate dimension labeling data, of the teaching record sample, labeled by multiple labeling models, based on the normalized response data of the third question and the fourth question; an instruction configured for averaging the third intermediate dimension labeling data, to obtain fourth intermediate dimension labeling data of the teaching record sample with respect to the teacher style semantic space; and an instruction configured for normalizing the fourth intermediate dimension labeling data to obtain the second dimension data.

Optionally, the instruction configured for normalizing the response data of the third question and the fourth question respectively to obtain the normalized response data of the third question and the fourth question, includes: an instruction configured for determining a third mean value and a third standard deviation of the response data of multiple teaching record samples with respect to the third question, and a fourth mean value and a fourth standard deviation of the response data of multiple teaching record samples with respect to the fourth question; an instruction configured for normalizing the response data of the third question based on the third mean value and the third standard deviation, to obtain normalized response data of the third question; and an instruction configured for normalizing the response data of the fourth question based on the fourth mean value and the fourth standard deviation, to obtain normalized response data of the fourth question.

Optionally, the teacher style labeling data includes teacher style labeling data, of the teaching record sample, labeled by multiple labeling models; and the instruction configured for performing the teacher style processing on the teacher style labeling data of the teaching record sample, to obtain the teacher style corresponding to the teaching record sample, includes: an instruction configured for determining an amount of same teacher style labeling data in the teacher style labeling data, of the teaching record sample, labeled by multiple labeling models; and an instruction configured for determining the teacher style corresponding to the teaching record sample based on the amount.

Optionally, the instruction configured for determining the teacher style representation data, corresponding to the teacher style corresponding to the teaching record sample, in the teacher style semantic space, based on the dimension data of the teaching record sample with respect to the teacher style semantic space and the teacher style corresponding to the teaching record sample, includes: an instruction configured for determining a number of teaching record samples, with a same teacher style as the teacher style, in multiple teaching record samples; and an instruction configured for determining the teacher style representation data, corresponding to the teacher style, in the teacher style semantic space based on the number and the dimension data.

Through the computer storage medium provided by the embodiment of the present disclosure, a feature extraction operation is performed on teaching record data acquired, to obtain feature data corresponding to the teaching record data; teacher style representation data corresponding to the teaching record data is predicted according to the feature data corresponding to the teaching record data through a teacher style prediction model; and a mapping operation is performed in a predetermined teacher style semantic space according to the teacher style representation data corresponding to the teaching record data, to determine a teacher style corresponding to the teaching record data. Compared with other existing methods, the teacher style corresponding to the teaching record data can be accurately determined through the predetermined teacher style semantic space.

It should be noted that according to the needs of implementation, each component/operation described in the embodiments of the present disclosure can be divided into more components/operations, or two or more components/operations or partial operations of components/operations can be combined into a new component/operation, to achieve the purpose of the embodiments of the present disclosure.

The above methods according to the embodiments of the present disclosure can be implemented in hardware, firmware, or implemented as software or computer code that can be stored in a recording medium (such as CD ROM, RAM, a floppy disk, a hard disk or a magneto-optical disk), or implemented as computer codes downloaded through a network, which are originally stored in a remote recording medium or a non-transitory machine-readable medium and will be stored in a local recording medium, such that the methods described herein can be processed by such software stored on the recording medium using a general-purpose computer, a special-purpose processor, or programmable or special hardware (such as ASIC or FPGA). It can be understood that a computer, a processor, a microprocessor controller or programmable hardware includes a storage component (for example, RAM, ROM, a flash memory, etc.) that can store or receive software or computer codes. When the software or computer code is accessed and executed by the computer, the processor or the hardware, the method for determining a teacher style described herein is implemented. In addition, when the general-purpose computer accesses the codes for implementing the method for determining a teacher style shown herein, the execution of the codes converts the general-purpose computer into a special-purpose computer for executing the method for determining a teacher style shown herein.

Those skilled in the art can realize that the units and method operations of each example described in connection with the embodiments disclosed herein can be implemented in electronic hardware, or a combination of computer software and electronic hardware. Whether these functions are performed in hardware or software depends on the specific application and the design constraint condition of the technical solution. Professional technicians can use different methods to implement the described functions for each specific application, but such implementation should not be considered to be beyond the scope of embodiments of the present disclosure.

The above implementation is only used to illustrate the embodiments of the present disclosure, but does not limit the embodiments of the present disclosure. Ordinary technicians in the relevant technical field can also make various changes and modifications without departing from the spirit and scope of the embodiments of the present disclosure. Therefore, all equivalent technical solutions also belong to the scope of the embodiments of the present disclosure, and the scope of patent protection of the embodiments of the present disclosure shall be defined by the claims.

What is claimed is:

1. A method for determining a teacher style, comprising:
performing a feature extraction operation on teaching record data acquired, to obtain feature data corresponding to the teaching record data;
predicting teacher style representation data corresponding to the teaching record data according to the feature data corresponding to the teaching record data through a teacher style prediction model; and
performing a mapping operation in a predetermined teacher style semantic space according to the teacher style representation data corresponding to the teaching record data, to determine the teacher style corresponding to the teaching record data.

2. The method of claim 1, wherein before performing the mapping operation in the predetermined teacher style semantic space according to the teacher style representation data corresponding to the teaching record data, to determine the teacher style corresponding to the teaching record data, the method further comprises:
performing dimensional processing on dimension labeling data of a teaching record sample with respect to the teacher style semantic space, to obtain dimension data of the teaching record sample with respect to the teacher style semantic space;
performing teacher style processing on teacher style labeling data of the teaching record sample, to obtain the teacher style corresponding to the teaching record sample;
determining the teacher style representation data, corresponding to the teacher style corresponding to the teaching record sample, in the teacher style semantic space, based on the dimension data of the teaching record sample with respect to the teacher style semantic space and the teacher style corresponding to the teaching record sample; and
determining the teacher style semantic space based on the teacher style representation data, corresponding to the teacher style corresponding to the teaching record sample, in the teacher style semantic space.

3. The method of claim 2, wherein the dimension labeling data comprises first dimension labeling data and second dimension labeling data of the teaching record sample with respect to the teacher style semantic space, and
the performing the dimensional processing on the dimension labeling data of the teaching record sample with respect to the teacher style semantic space, to obtain the dimension data of the teaching record sample with respect to the teacher style semantic space, comprises:
performing first dimension processing on the first dimension labeling data, to obtain first dimension data of the teaching record sample with respect to the teacher style semantic space; and
performing second dimension processing on the second dimension labeling data, to obtain second dimension data of the teaching record sample with respect to the teacher style semantic space.

4. The method of claim 3, wherein the first dimension labeling data comprises response data of a first question and a second question set by a plurality of labeling models for a first dimension of the teacher style semantic space; and
the performing the first dimension processing on the first dimension labeling data, to obtain the first dimension data of the teaching record sample with respect to the teacher style semantic space, comprises:
normalizing the response data of the first question and the second question respectively, to obtain normalized response data of the first question and the second question;
determining first intermediate dimension labeling data, of the teaching record sample, labeled by the plurality of labeling models, based on the normalized response data of the first question and the second question;
averaging the first intermediate dimension labeling data, to obtain second intermediate dimension labeling data of the teaching record sample with respect to the teacher style semantic space; and
normalizing the second intermediate dimension labeling data to obtain the first dimension data.

5. The method of claim 4, wherein the normalizing the response data of the first question and the second question respectively, to obtain the normalized response data of the first question and the second question, comprises:
determining a first mean value and a first standard deviation of the response data of a plurality of teaching record samples with respect to the first question, and a second mean value and a second standard deviation of the response data of the plurality of teaching record samples with respect to the second question;
normalizing the response data of the first question based on the first mean value and the first standard deviation, to obtain the normalized response data of the first question; and
normalizing the response data of the second question based on the second mean value and the second standard deviation, to obtain the normalized response data of the second question.

6. The method of claim 3, wherein the second dimension labeling data comprises response data of a third question and a fourth question set by a plurality of labeling models for a second dimension of the teacher style semantic space; and
the performing the second dimension processing on the second dimension labeling data, to obtain the second dimension data of the teaching record sample with respect to the teacher style semantic space, comprises:
normalizing the response data of the third question and the fourth question respectively, to obtain normalized response data of the third question and the fourth question;
determining third intermediate dimension labeling data, of the teaching record sample, labeled by the plurality of labeling models, based on the normalized response data of the third question and the fourth question;
averaging the third intermediate dimension labeling data, to obtain fourth intermediate dimension labeling data of the teaching record sample with respect to the teacher style semantic space; and
normalizing the fourth intermediate dimension labeling data to obtain the second dimension data.

7. The method of claim 6, wherein the normalizing the response data of the third question and the fourth question respectively, to obtain the normalized response data of the third question and the fourth question, comprises:
determining a third mean value and a third standard deviation of the response data of a plurality of teaching record samples with respect to the third question, and a fourth mean value and a fourth standard deviation of the response data of the plurality of teaching record samples with respect to the fourth question;
normalizing the response data of the third question based on the third mean value and the third standard deviation, to obtain normalized response data of the third question; and
normalizing the response data of the fourth question based on the fourth mean value and the fourth standard deviation, to obtain normalized response data of the fourth question.

8. The method of claim 2, wherein the teacher style labeling data comprises teacher style labeling data, of the teaching record sample, labeled by a plurality of labeling models; and
the performing the teacher style processing on the teacher style labeling data of the teaching record sample, to obtain the teacher style corresponding to the teaching record sample, comprises:
determining an amount of same teacher style labeling data in the teacher style labeling data, of the teaching record sample, labeled by the plurality of labeling models; and
determining the teacher style corresponding to the teaching record sample based on the amount.

9. The method of claim 2, wherein the determining the teacher style representation data, corresponding to the teacher style corresponding to the teaching record sample, in the teacher style semantic space, based on the dimension data of the teaching record sample with respect to the teacher style semantic space and the teacher style corresponding to the teaching record sample, comprises:
determining a number of teaching record samples, with the same teacher style as the teacher style, in a plurality of teaching record samples; and
determining the teacher style representation data, corresponding to the teacher style, in the teacher style semantic space based on the number and the dimension data.

10. A non-transitory computer-readable medium storing a readable program, wherein the readable program, when executed by a processor, causes the processor to perform operations of:
performing a feature extraction operation on teaching record data acquired, to obtain feature data corresponding to the teaching record data;
predicting teacher style representation data corresponding to the teaching record data according to the feature data corresponding to the teaching record data through a teacher style prediction model; and
performing a mapping operation in a predetermined teacher style semantic space according to the teacher style representation data corresponding to the teaching record data, to determine the teacher style corresponding to the teaching record data.

11. The non-transitory computer-readable medium of claim 10, wherein
before performing the mapping operation in the predetermined teacher style semantic space according to the teacher style representation data corresponding to the teaching record data, to determine the teacher style corresponding to the teaching record data, the readable program, when executed by the processor, causes the processor to further perform operations of:
performing dimensional processing on dimension labeling data of a teaching record sample with respect to the teacher style semantic space, to obtain dimension data of the teaching record sample with respect to the teacher style semantic space;
performing teacher style processing on teacher style labeling data of the teaching record sample, to obtain the teacher style corresponding to the teaching record sample;
determining the teacher style representation data, corresponding to the teacher style corresponding to the teaching record sample, in the teacher style semantic space, based on the dimension data of the teaching record sample with respect to the teacher style semantic space and the teacher style corresponding to the teaching record sample; and
determining the teacher style semantic space based on the teacher style representation data, corresponding to the teacher style corresponding to the teaching record sample, in the teacher style semantic space.

12. The non-transitory computer-readable medium of claim 11, wherein the dimension labeling data comprises first dimension labeling data and second dimension labeling data of the teaching record sample with respect to the teacher style semantic space; and
the performing the dimensional processing on the dimension labeling data of the teaching record sample with respect to the teacher style semantic space, to obtain the dimension data of the teaching record sample with respect to the teacher style semantic space, comprises:
performing first dimension processing on the first dimension labeling data, to obtain first dimension data of the teaching record sample with respect to the teacher style semantic space; and
performing second dimension processing on the second dimension labeling data, to obtain second dimension data of the teaching record sample with respect to the teacher style semantic space.

13. The non-transitory computer-readable medium of claim 12, wherein the first dimension labeling data comprises response data of a first question and a second question set by a plurality of labeling models for a first dimension of the teacher style semantic space; and
the performing the first dimension processing on the first dimension labeling data, to obtain the first dimension data of the teaching record sample with respect to the teacher style semantic space, comprises:
normalizing the response data of the first question and the second question respectively, to obtain normalized response data of the first question and the second question;
determining first intermediate dimension labeling data, of the teaching record sample, labeled by the plurality of labeling models, based on the normalized response data of the first question and the second question;
averaging the first intermediate dimension labeling data, to obtain second intermediate dimension labeling data of the teaching record sample with respect to the teacher style semantic space; and
normalizing the second intermediate dimension labeling data to obtain the first dimension data.

14. The non-transitory computer-readable medium of claim 13, wherein the normalizing the response data of the first question and the second question respectively, to obtain the normalized response data of the first question and the second question, comprises:
determining a first mean value and a first standard deviation of the response data of a plurality of teaching record samples with respect to the first question, and a second mean value and a second standard deviation of the response data of the plurality of teaching record samples with respect to the second question;
normalizing the response data of the first question based on the first mean value and the first standard deviation, to obtain the normalized response data of the first question; and
normalizing the response data of the second question based on the second mean value and the second standard deviation, to obtain the normalized response data of the second question.

15. The non-transitory computer-readable medium of claim 12, wherein the second dimension labeling data comprises response data of a third question and a fourth question set by a plurality of labeling models for a second dimension of the teacher style semantic space; and
the performing the second dimension processing on the second dimension labeling data, to obtain the second dimension data of the teaching record sample with respect to the teacher style semantic space, comprises:
normalizing the response data of the third question and the fourth question respectively, to obtain normalized response data of the third question and the fourth question;
determining third intermediate dimension labeling data, of the teaching record sample, labeled by the plurality of labeling models, based on the normalized response data of the third question and the fourth question;
averaging the third intermediate dimension labeling data, to obtain fourth intermediate dimension labeling data of the teaching record sample with respect to the teacher style semantic space; and
normalizing the fourth intermediate dimension labeling data to obtain the second dimension data.

16. The non-transitory computer-readable medium of claim 15, wherein the normalizing the response data of the third question and the fourth question respectively, to obtain the normalized response data of the third question and the fourth question, comprises:
determining a third mean value and a third standard deviation of the response data of a plurality of teaching record samples with respect to the third question, and a fourth mean value and a fourth standard deviation of the response data of the plurality of teaching record samples with respect to the fourth question;
normalizing the response data of the third question based on the third mean value and the third standard deviation, to obtain normalized response data of the third question; and
normalizing the response data of the fourth question based on the fourth mean value and the fourth standard deviation, to obtain normalized response data of the fourth question.

17. The non-transitory computer-readable medium of claim 11, wherein the teacher style labeling data comprises teacher style labeling data, of the teaching record sample, labeled by a plurality of labeling models; and
the performing the teacher style processing on the teacher style labeling data of the teaching record sample, to obtain the teacher style corresponding to the teaching record sample, comprises:
determining an amount of same teacher style labeling data in the teacher style labeling data, of the teaching record sample, labeled by the plurality of labeling models; and
determining the teacher style corresponding to the teaching record sample based on the amount.

18. The non-transitory computer-readable medium of claim 11, wherein the determining the teacher style representation data, corresponding to the teacher style corresponding to the teaching record sample, in the teacher style semantic space, based on the dimension data of the teaching record sample with respect to the teacher style semantic space and the teacher style corresponding to the teaching record sample, comprises:
determining a number of teaching record samples, with a same teacher style as the teacher style, in a plurality of teaching record samples; and
determining the teacher style representation data, corresponding to the teacher style, in the teacher style semantic space based on the number and the dimension data.
